(19) United States
(12) Patent Application Publication
(10) Pub. No.: US 2026/0142408 A1
(43) Pub. Date: May 21, 2026

(54) Assembled Type Waterproof Power Plug Component

(71) Applicant: Weiping Zhou, Tianjin (CN)

(72) Inventor: Weiping Zhou, Tianjin (CN)

(21) Appl. No.: 18/704,691

(22) PCT Filed: Sep. 29, 2022
(86) PCT No.: PCT/CN2022/122575

§ 371 Date: Apr. 25, 2024

(30) Foreign Application Priority Data
Oct. 25, 2021 (CN) 202111244413.0

(51) Int. Cl. H01R 13/52; H01R 13/508; H01R 13/66; H01R 24/28; H01R 103/00

(52) U.S. Cl. CPC H01R 13/5202; H01R 13/508; H01R 13/5208; H01R 13/5216; H01R 13/6658; H01R 24/28; H01R 2103/00

(57) ABSTRACT

The present disclosure is an assembled type waterproof power plug component, which includes a direct plug, a back plug, a tail plug socket, and an end cap; the direct plug, the back plug, and the end cap are provided with sealing components; the sealing components are used for sealing joints; spacers are arranged in the direct plug, the back plug, and the tail plug socket; by the arrangement of the spacers, cavities for placing circuit boards are respectively formed in the direct plug, the back plug, and the tail plug socket; sealing components are respectively arranged at two ends of the cavities, so that the cavities are formed into closed cavities; insulation sealants are poured into the closed cavities; the component is further provided with an anti-separation buckle, an anti-separation buckle fixing part, and an anti-separation clamping slot; the anti-separation buckle is fixed at the anti-separation buckle fixing part.

### TECHNICAL FIELD

The present disclosure relates to the technical field of power plugs, and in particular, to an assembled type waterproof power plug component.

### BACKGROUND

There are various forms of existing assembled type light string power plug assemblies, generally including a direct plug, a back plug, and a tail plug socket. In order to meet usage needs, the direct plug, the back plug, and the tail connection socket can be combined for use. However, the applicant has found that the existing assembled type light string power plug assemblies do not have waterproof functions with each other, and electrified bodies (namely, copper tools and wires in the various assemblies) of the direct plug, the back plug, and the tail connection socket are exposed to the air. There is a risk of electric shock if a light string is used in the rain or puddles. Therefore, providing an assembled type power plug component with a waterproof function has become an urgent technical problem needing to be solved by those skilled in the art.

### SUMMARY

One of the objectives of the present disclosure is to provide an assembled type waterproof power plug component, which solves the technical problem that an assembled type power plug component in the prior art does not have a waterproof function. Many technical effects achieved by the optional technical solutions of the present disclosure are described below.

In order to achieve the above objectives, the present disclosure provides the following technical solutions:

An assembled type waterproof power plug component of the present disclosure, comprising a direct plug, a back plug, a tail plug socket, and an end cap, wherein, the direct plug, the back plug, and the end capare provided with sealing components; when at least two of the direct plug, the back plug, the tail plug socket, and the end cap are connected, the sealing components are used for sealing joints; spacers are arranged in the direct plug, the back plug, and the tail plug socket to form cavities for placing circuit boards in the direct plug, the back plug, and the tail plug socket; first sealing components and/or second sealing components are respectively arranged at two ends of the cavities, so that the cavities are formed into closed cavities; insulation sealants are poured into the closed cavities; after being cured, the insulation sealants wrap up and fix the circuit boards in the cavities; the back plug and the tail plug socket are further provided with anti-separation buckles and anti-separation buckle fixing parts; the anti-separation buckles are fixed at the anti-separation buckle fixing parts; anti-separation clamping slots are further arranged on the direct plug, the back plug, and the end cap; and when at least two of the direct plug, the back plug, the tail plug socket, and the end cap are connected, the anti-separation buckles are buckled at the anti-separation clamping slots to firmly buckle and fix the joints.

According to a preferred implementation, a first sealing groove, a second sealing groove, and a third sealing groove are respectively arranged on the direct plug, the back plug, and the end cap; and the sealing components are sealing rings placed in the first sealing groove, the second sealing groove, and the third sealing groove.

According to a preferred implementation, a first spacer is arranged in the middle of the direct plug; two sides of the first spacer are respectively formed into a first cavity used for accommodating an inner bracket component and a second cavity for accommodating the circuit board; the first sealing components are arranged on the two sides of the first spacer; the second sealing component is arranged at one end of the second cavity away from the first spacer; the first sealing components and the second sealing component wrap up and fix wires that respectively pass through the first sealing components, the first spacer, and the second sealing component, so that the second cavity is formed into a closed cavity; a second spacer and a third spacer are arranged in the back plug; two sides of the second spacer are respectively formed into a third cavity used for accommodating the inner bracket component and a fourth cavity used for being connected to the direct plug, the back plug, or the end cap; two sides of the third spacer are respectively formed into the fourth cavity and a fifth cavity used for accommodating the circuit board; the first sealing component is arranged at one end of the fifth cavity close to the third spacer; the second sealing component is arranged at one end of the fifth cavity away from the third spacer; the first sealing component and the second sealing component wrap up and fix wires that pass through the first sealing component, the third spacer, and the second sealing component, so that the fifth cavity is formed into a closed cavity; a fourth spacer is arranged in the middle of the tail plug socket; two sides of the fourth spacer are respectively formed into a sixth cavity used for accommodating the inner bracket component and a seventh cavity for accommodating the circuit board; the first sealing components are arranged on the two sides of the fourth spacer; the second sealing component is arranged at one end of the seventh cavity away from the fourth spacer; the first sealing components and the second sealing component wrap up and fix wires that respectively pass through the first sealing components, the fourth spacer, and the second sealing component, so that the seventh cavity is formed into a closed cavity; the insulation sealants are poured into the closed second cavity, the closed fifth cavity, and the closed seventh cavity; after being cured, the insulation sealants wrap up and fix the circuit boards and the wires in the second cavity, the fifth cavity, and the seventh cavity; and the circuit boards are provided with circuits that connect alternating current power at an input end to an output end; or rectification circuits that convert alternating current power at an input end into direct current power at an output end; or time control circuits that control powering on and powering off at the output end.

According to a preferred implementation, the inner bracket component comprises an inner bracket and electrical elements arranged on the inner bracket; a tail part of the inner bracket of the direct plug has two relatively arranged hooks; the hooks pass through through holes on the first spacer and extend into the second cavity; a tail part of the inner bracket of the back plug has three equilateral triangle-shaped hooks; the hooks are hooked to the second spacer and fix the inner bracket to the second spacer; a tail part of the inner bracket of the tail plug socket has two relatively arranged hooks; the hooks pass through through holes on the fourth spacer and extend into the seventh cavity; the hooks of the inner bracket of the direct plug and the tail plug socket form a sliding chute for clamping the first sealing components; and a sliding chute for clamping the first sealing component is arranged on one side of the fifth cavity on the third spacer of the back plug.

According to a preferred implementation, each of the first sealing components arranged on the two sides of the first spacer and the two sides of the fourth spacer comprises a first wire locating piece and a first stop piece; the first wire locating piece is arranged in the second cavity and the seventh cavity and is clamped in the sliding chute formed by the hooks of the inner bracket, and the inner bracket is fixed on the first spacer or the fourth spacer; the first stop piece is a soft rubber stop piece arranged in the first cavity and the sixth cavity and located at a tail part of the inner bracket component to seal the through holes on the first spacer and the fourth spacer; the first sealing component arranged in the fifth cavity comprises a first wire locating piece; the first wire locating piece is clamped in the sliding chute on the third spacer; each of the second sealing components comprises a second wire locating piece and a third wire locating piece; the second wire locating piece is a hard rubber stop piece; the third wire locating piece is a soft rubber stop piece; the second wire locating piece and the third wire locating piece are provided with two, three, or four through holes for allowing a wire to pass through; and a hole diameter of the through hole on the third wire locating piece is smaller than a diameter of the wire.

According to a preferred implementation, first bosses are arranged on one sides of the first wire locating pieces that are in contact with the first spacer of the direct plug, the third spacer of the back plug, and the fourth spacer of the tail plug socket; the first bosses are clamped and fixed to mounting holes on the first spacer, the third spacer, and the fourth spacer; the first wire locating pieces are further provided with first recesses with downward openings; one end of each first recess away from the opening is of a semicircular structure having the same diameter as the diameter off the wire; second recesses with upward openings are further arranged at lower ends of the through holes, which are used for allowing the wires to pass through, on the first spacer, the third spacer, and the fourth spacer; each second recess is of a semicircular structure having the same diameter as the diameter of the wire; and the first recesses and the second recesses are abutted up and down to wrap up and fix the wires that pass through the first recesses and the second recesses.

According to a preferred implementation, the direct plug, the back plug, and the tail plug socket are provided with fourth grooves used for fixing the second wire locating pieces and the third wire locating pieces; a sum of thicknesses of each second wire locating piece and each third wire locating piece is greater than or equal to a width of each fourth groove; second bosses are arranged on the second wire locating pieces; third bosses are arranged in the fourth grooves; and when the second sealing components are inserted into the fourth grooves, the second bosses and the third bosses are misaligned to fix the second wire locating pieces in the fourth grooves.

According to a preferred implementation, two insertion slots, as well as a first clamping slot and a stop part which are located between the two insertion slots, are arranged in the middle of one surface of each anti-separation buckle that is in contact with the anti-separation buckle fixing part; a buckling part is arranged at an end portion of the surface of the anti-separation buckle that is in contact with the anti-separation buckle fixing part; the anti-separation buckle fixing parts arranged on the back plug and the tail plug socket comprise two insertion sheets, and an inverted buckle part is also arranged between the two insertion sheets; when each anti-separation buckle is fixed on each anti-separation buckle fixing part, the insertion sheets are inserted into the insertion slots, the inverted buckle part is buckled in the first clamping slot and resists against the stop part, so that the anti-separation buckle is unable to be separated from the anti-separation buckle fixing part; and when at least two of the direct plug, the back plug, the tail plug socket, and the end cap are connected, the buckling part of the anti-separation buckle is clamped in the anti-separation clamping slot, so as to firmly fix the joint.

According to a preferred implementation, the stop part is of a T-shaped structure; a transverse edge of the stop part is used for resisting against the inverted buckle part; a vertical edge of the stop part is of a structure that protrudes out of a surface of the anti-separation buckle at a height gradually decreasing from one end close to the transverse edge to one end away from the transverse edge; the inverted buckle part is provided with a reinforcing rib; and the reinforcing rib is of a structure having a protruding height that gradually decreases from one end close to the inverted buckle part to one end away from the inverted buckle part.

According to a preferred implementation, a fixed through hole is arranged at a top of the end cap; two symmetrical arc-shaped grooves are arranged on an outer circumference, concentric with the fixed through hole, of the top of the end cap; a third recess is arranged between the two arc-shaped grooves; a fourth boss, a fifth boss, and a sixth boss are arranged on a shell of each of the back plug and the tail plug socket; the fifth boss and the sixth boss are located on two sides of the fourth boss; when the back plug with the end cap and the tail plug socket with the end cap are connected to other plug components, the end caps arranged in both the back plug and the tail plug socket are taken out and are fixed on the shells of the back plug and the tail plug socket; and the end caps are fixed on the shells of the back plug and the tail plug socket in the following way: inserting the fourth bosses into the fixed through holes, rotating the end caps by 90° to clamp the tops of the fourth bosses into inner sides of the tops of the end caps, and embedding the fifth bosses and the sixth bosses into the two third recesses between the arc-shaped grooves respectively.

The assembled type waterproof power plug component provided by the present disclosure at least has the following beneficial effects:
According to the assembled type waterproof power plug component of the present disclosure, on the one hand, the sealing components are arranged on the direct plug, the back plug, and the end cap, so that when at least two of the direct plug, the back plug, the tail plug socket, and the end cap are connected, the joints can be sealed through the sealing components to achieve a waterproof effect. On the other hand, the first sealing components and/or the second sealing components are respectively arranged at two ends of the cavities, used for placing the circuit boards, of the direct plug, the back plug, and the tail plug socket, so that the cavities are formed into the closed cavities. The insulation sealants are poured into the closed cavities. After being cured, the insulation sealants wrap up and fix the circuit boards in the cavities, which can achieve a waterproof effect. Thirdly, the back plug and the tail plug socket are provided with the anti-separation buckles and the anti-separation buckle fixing parts; the anti-separation buckles are fixed at the anti-separation buckle fixing parts, so as to be prevented from being separated; the anti-separation clamping slots are arranged on the direct plug, the back plug, and the end cap; and at least two of the direct plug, the back plug, the tail plug socket, and the end cap are connected, the anti-separation buckles are buckled at the anti-separation clamping slots to firmly buckle and fix the joints. This avoids looseness of the joints, ensures the stability of the joints, and further achieves the waterproof effect. Therefore, due to the anti-separation structures at sealed, closed, sealant pouring, and connection positions, the assembled type waterproof power plug component of the present disclosure has the advantage of good waterproof effect and can be used in the rain or puddles. That is, through the arrangement of the multiple waterproof structures, the assembled type waterproof power plug component of the present disclosure solves the technical problem that an assembled type power plug component in the prior art does not have a waterproof function.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a first schematic diagram of a preferred implementation of a direct plug according to the present disclosure;

FIG. 2 is a second schematic diagram of a preferred implementation of a direct plug according to the present disclosure;

FIG. 3 is a third schematic diagram of a preferred implementation of a direct plug according to the present disclosure;

FIG. 4 is a first schematic diagram of a preferred implementation of a back plug according to the present disclosure;

FIG. 5 is a second schematic diagram of a preferred implementation of a back plug according to the present disclosure;

FIG. 6 is a third schematic diagram of a preferred implementation of a back plug according to the present disclosure;

FIG. 7 is a fourth schematic diagram of a preferred implementation of a back plug according to the present disclosure;

FIG. 8 is a first schematic diagram of a preferred implementation of a tail plug socket according to the present disclosure;

FIG. 9 is a second schematic diagram of a preferred implementation of a tail plug socket according to the present disclosure;

FIG. 10 is a third schematic diagram of a preferred implementation of a tail plug socket according to the present disclosure;

FIG. 11 is a first schematic diagram of a preferred implementation of an end cap according to the present disclosure;

FIG. 12 is a second schematic diagram of a preferred implementation of an end cap according to the present disclosure;

FIG. 13 is a third schematic diagram of a preferred implementation of an end cap stop piece according to the present disclosure;

FIG. 14 is a schematic diagram of connection and use of a back plug, a back plug, and an end cap according to the present disclosure;

FIG. 15 is a schematic diagram of connection and use of a back plug and a direct plug according to the present disclosure;

FIG. 16 is a schematic diagram of connection and use of a back plug and an end cap according to the present disclosure;

FIG. 17 is a schematic diagram of connection and use of a tail plug socket, a back plug, and an end cap according to the present disclosure;

FIG. 18 is a schematic diagram of connection and use of a tail plug socket and an end cap according to the present disclosure;

FIG. 19 is a schematic diagram of connection and use of a tail plug socket and a direct plug according to the present disclosure;

FIG. 20 is a schematic diagram of connection and use of a tail plug socket, a back plug, a back plug, and an end cap according to the present disclosure;

FIG. 21 is a schematic diagram of connection and use of a tail plug socket, a back plug, a direct plug, and an end cap according to the present disclosure;

FIG. 22 is a schematic diagram of a preferred implementation of a first wire locating piece according to the present disclosure;

FIG. 23 is a third schematic diagram of a preferred implementation of a first stop piece according to the present disclosure;

FIG. 24 is a first schematic diagram of cooperation between a second wire locating piece and a third wire locating piece according to the present disclosure;

FIG. 25 is a second schematic diagram of cooperation between a second wire locating piece and a third wire locating piece according to the present disclosure;

FIG. 26 is a schematic diagram of another preferred implementation of cooperation between a second wire locating piece and a third wire locating piece according to the present disclosure;

FIG. 27 is a schematic diagram of a preferred implementation of an inner bracket of a direct plug according to the present disclosure;

FIG. 28 is a schematic diagram of a preferred implementation of an inner bracket of a back plug according to the present disclosure;

FIG. 29 is a schematic diagram of a preferred implementation of an inner bracket of a tail plug socket according to the present disclosure;

FIG. 30 is a schematic diagram of a preferred implementation of an inner bracket insertion sheet according to the present disclosure;

FIG. 31 is a schematic diagram of a preferred implementation of an anti-separation buckle according to the present disclosure;

FIG. 32 is a schematic diagram of combining an inner bracket of a direct plug with a first stop piece; and

FIG. 33 is a schematic diagram of combining an inner bracket of a tail plug socket and a first stop piece.

In the drawings: 10: direct plug; 101: first sealing groove; 102: first spacer; 103: first cavity; 104: second cavity; 20: back plug; 201: second sealing groove; 202: second spacer; 203: third spacer; 204: third cavity; 205: fourth cavity; 206: fifth cavity; 30: tail plug socket; 301: fourth spacer; 302: sixth cavity; 303: seventh cavity; 40: end cap; 401: third sealing groove; 402: fixed through hole; 403: arc-shaped groove; 404: third recess; 405: fourth boss; 406: fifth boss; 407: sixth boss; 408: accommodating chamber; 409: end cap stop piece; 501: first wire locating piece; 5011: first boss; 5012: first recess; 5013: second recess; 502: first stop piece; 503: second wire locating piece; 5031: second boss; 504: third wire locating piece; 505: fourth groove; 5051: third boss; 60: anti-separation buckle; 601: insertion slot; 602: first clamping slot; 603: stop part; 604: buckling part; 70: anti-separation buckle fixing part; 701: insertion sheet; 702: inverted buckle part; 7021: reinforcing rib; and 80: anti-separation clamping slot.

### DETAILED DESCRIPTION OF THE EMBODIMENTS

In order to make the objectives, technical solutions, and advantages of the present disclosure clearer, a detailed description of the technical solutions of the present disclosure will be provided below. Apparently, the described embodiments are merely some embodiments of the present disclosure, rather than all of the embodiments. All other implementations obtained by a person of ordinary skill in the art based on the embodiments of the present disclosure without creative efforts shall fall within the protection scope of the present disclosure.

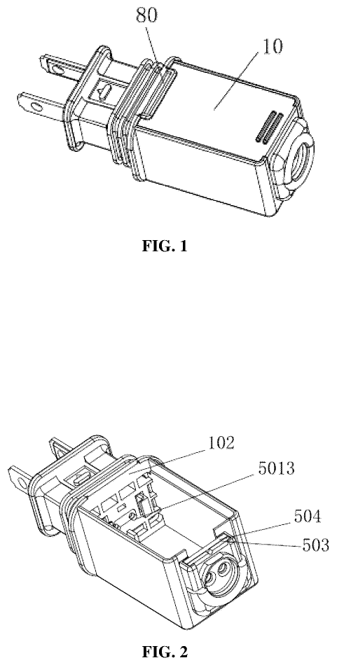

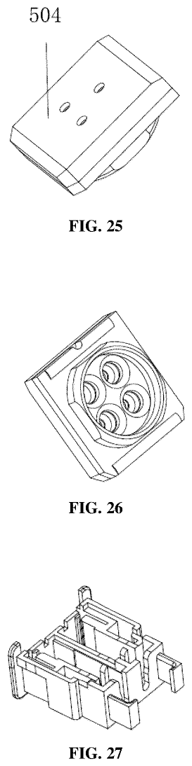

An assembled type waterproof power plug component of the present disclosure will be explained below with reference to FIG. 1 to FIG. 33.

The assembled type waterproof power plug component of this embodiment includes a direct plug 10, a back plug 20, a tail plug socket 30, and an end cap 40, as shown in FIG. 1 to FIG. 13. Preferably, the direct plug 10, the back plug 20, and the end cap 40 are provided with sealing components; and when at least two of the direct plug 10, the back plug 20, the tail plug socket 30, and the end cap 40 are connected, the sealing components are used for sealing joints. Preferably, spacers are arranged in the direct plug 10, the back plug 20, and the tail plug socket 30 to form cavities for placing circuit boards in the direct plug 10, the back plug 20, and the tail plug socket 30; first sealing components and/or second sealing components are respectively arranged at two ends of the cavities, so that the cavities are formed into closed cavities; insulation sealants are poured into the closed cavities; and after being cured, the insulation sealants wrap up and fix the circuit boards in the cavities. Preferably, the back plug 20 and the tail plug socket 30 are further provided with anti-separation buckles 60 and anti-separation buckle fixing parts 70; the anti-separation buckles 60 are fixed at the anti-separation buckle fixing parts 70; anti-separation clamping slots 80 are further arranged on the direct plug 10, the back plug 20, and the end cap 40; and when at least two of the direct plug 10, the back plug 20, the tail plug socket 30, and the end cap 40 are connected, the anti-separation buckles 60 are buckled at the anti-separation clamping slots 80 to firmly buckle and fix the joints.

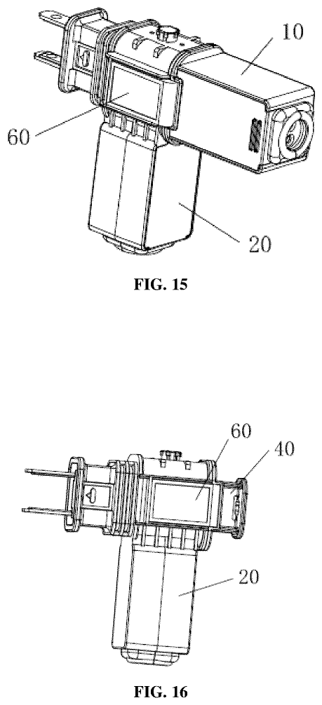

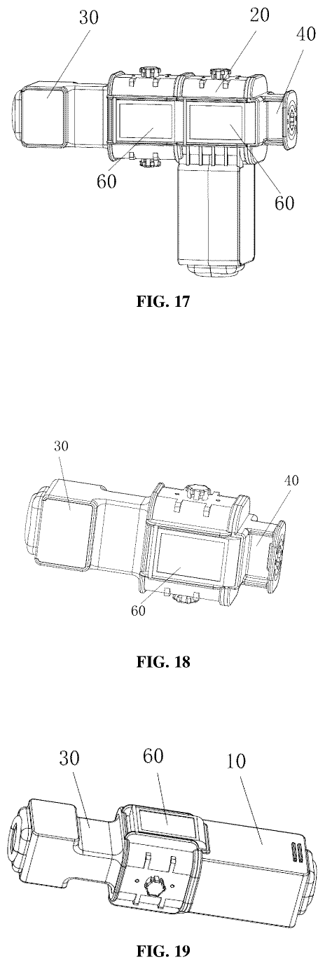

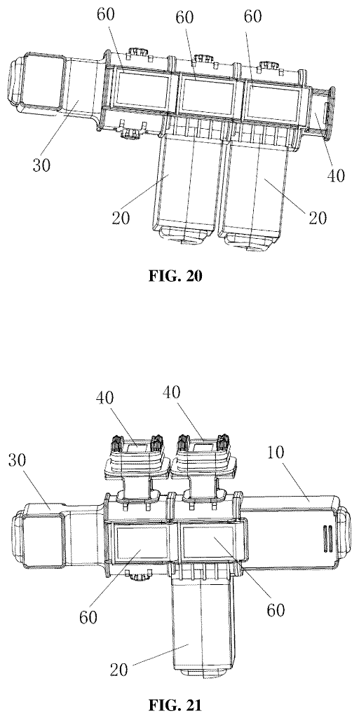

In this embodiment, when at least two of the direct plug 10, the back plug 20, the tail plug socket 30, and the end cap 40 are connected, there may be one or more of direct plugs 10, back plugs 20, tail plug sockets 30, and end caps 40. For example, FIG. 14 is a schematic diagram of connection and use of a back plug 20, a back plug 20, and an end cap 40; FIG. 15 is a schematic diagram of connection and use of a back plug 20 and a direct plug 10; FIG. 16 is a schematic diagram of connection and use of a back plug 20 and an end cap 40; FIG. 17 is a schematic diagram of connection and use of a tail plug socket 30, a back plug 20, and an end cap 40; FIG. 18 is a schematic diagram of connection and use of a tail plug socket 30 and an end cap 40; FIG. 19 is a schematic diagram of connection and use of a tail plug socket 30 and a direct plug 10; FIG. 20 is a schematic diagram of connection and use of a tail plug socket 30, a back plug 20, a back plug 20, and an end cap 40; and FIG. 21 is a schematic diagram of connection and use of a tail plug socket 30, a back plug 20, a direct plug 10, and an end cap 40. This is not limited here, or it may be other combination forms.

It should be particularly noted that only the combination forms shown in FIG. 17 to FIG. 21 have a waterproof effect. The combination forms shown in FIG. 14 to FIG. 16 cannot be used alone as waterproof power plug components because copper tools are exposed to the air. That is, the direct plug 10 has a waterproof effect only when it is used with the back plug 20 and/or the tail plug socket 30, as shown in FIG. 19 or FIG. 21. The back plug 20 with the end cap 40 has a waterproof effect only when it is used with the tail plug socket 30 and/or another back plug 20, as shown in FIG. 17 or FIG. 20. The tail plug socket 30 has a waterproof effect only when it is used with the end cap 40, the direct plug 10, and/or the back plug 20 with the end cap 40, as shown in FIG. 17 to FIG. 19.

According to the assembled type waterproof power plug component of this embodiment, on the one hand, the sealing components are arranged on the direct plug 10, the back plug 20, and the end cap 40, so that when at least two of the direct plug 10, the back plug 20, the tail plug socket 30, and the end cap 40 are connected, the joints can be sealed through the sealing components to achieve a waterproof effect. On the other hand, the first sealing components and/or the second sealing components are respectively arranged at two ends of the cavities, used for placing the circuit boards, of the direct plug 10, the back plug 20, and the tail plug socket 30, so that the cavities are formed into the closed cavities. The insulation sealants are poured into the closed cavities. After being cured, the insulation sealants wrap up and fix the circuit boards in the cavities, which can achieve a waterproof effect. Thirdly, the back plug 20 and the tail plug socket 30 are provided with the anti-separation buckles 60 and the anti-separation buckle fixing parts 70; the anti-separation buckles 60 are fixed at the anti-separation buckle fixing parts 70, so as to be prevented from being separated; the anti-separation clamping slots 80 are arranged on the direct plug 10, the back plug 20, and the end cap 40; and at least two of the direct plug 10, the back plug 20, the tail plug socket 30, and the end cap 40 are connected, the anti-separation buckles 60 are buckled at the anti-separation clamping slots 80 to firmly buckle and fix the joints. This avoids looseness of the joints, ensures the stability of the joints, and further achieves the waterproof effect. Therefore, due to the anti-separation structures at sealed, closed, sealant pouring, and connection positions, the assembled type waterproof power plug component of this embodiment has the advantage of good waterproof effect and can be used in the rain or puddles. That is, through the arrangement of the multiple waterproof structures, the assembled type waterproof power plug component of this embodiment solves the technical problem that an assembled type power plug component in the prior art does not have a waterproof function.

According to a preferred implementation, a first sealing groove 101, a second sealing groove 201, and a third sealing groove 401 are respectively arranged on the direct plug 10, the back plug 20, and the end cap 40; and the sealing components are sealing rings placed in the first sealing groove 101, the second sealing groove 201, and the third sealing groove 401, as shown in FIG. 1 to FIG. 6 and FIG. 12. Preferably, the first sealing groove 101, the second sealing groove 201, and the third sealing groove 401 are arranged in at least two circles to place at least two circles of sealing rings, so as to enhance the sealing effect on the joints.

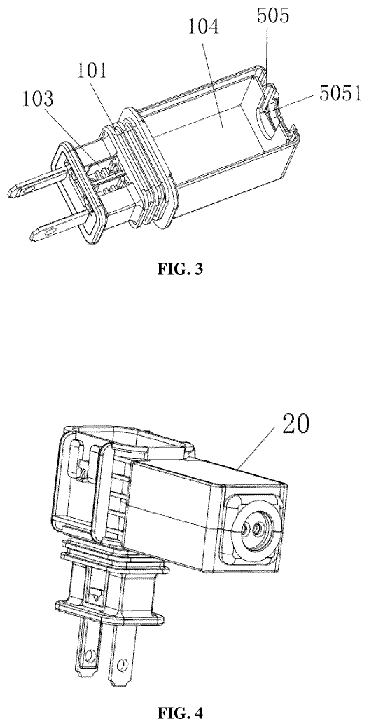

According to a preferred implementation, a first spacer 102 is arranged in the middle of the direct plug 10. Two sides of the first spacer 102 are respectively formed into a first cavity 103 used for accommodating an inner bracket component and a second cavity 104 for accommodating the circuit board, as shown in FIG. 2 or FIG. 3. Preferably, the first sealing components are arranged on the two sides of the first spacer 102; the second sealing component is arranged at one end of the second cavity 104 away from the first spacer 102; the first sealing components and the second sealing component wrap up and fix wires that respectively pass through the first sealing components, the first spacer 102, and the second sealing component, so that the second cavity 104 is formed into a closed cavity. More preferably, the insulation sealant is poured into the closed second cavity 104. After being cured, the insulation sealant wraps around and fixes the circuit board and the wire in the second cavity 104. The wires are connected to the circuit board. Specifically, the wires passing through the first sealing component and the first spacer 102 are connected to an input end of the circuit board, and the wire passing through the second sealing component is connected to an output end of the circuit board. According to the preferred technical solution of this embodiment, the second cavity 104 can be formed into the closed cavity through the action of the first sealing components and the second sealing component. When insulation sealant is poured into the closed second cavity 104, the insulation sealant will not seep out from two ends of the second cavity 104. After being cured, the insulation sealant will wrap up and fix the circuit board and all elements and solder joints on the circuit board in the second cavity 104, playing a role of external insulation.

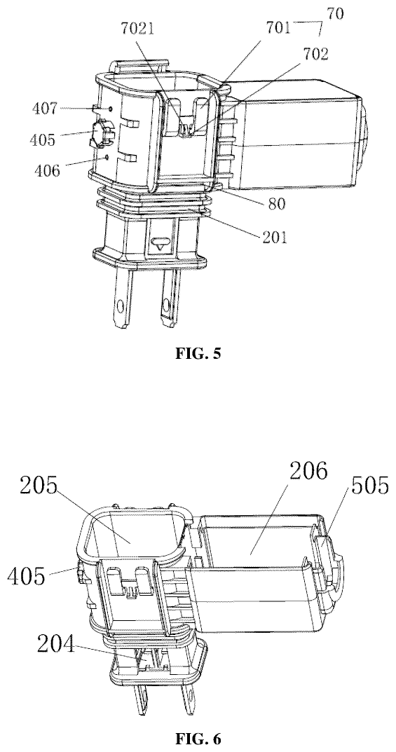

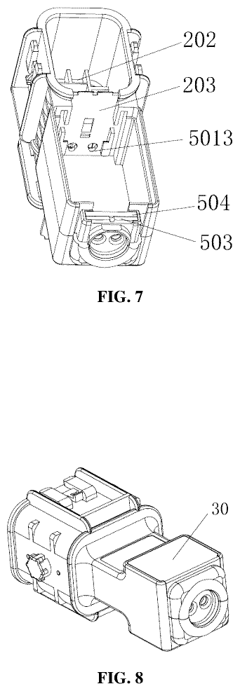

According to a preferred implementation, a second spacer 202 and a third spacer 203 are arranged in the back plug 20; two sides of the second spacer 202 are respectively formed into a third cavity 204 used for accommodating the inner bracket component and a fourth cavity 205 used for being connected to the direct plug 10, the back plug 20, or the end cap 40; and two sides of the third spacer 203 are respectively formed into the fourth cavity 205 and a fifth cavity 206 used for accommodating the circuit board, as shown in FIG. 6 or FIG. 7. The first sealing component is arranged at one end of the fifth cavity 206 close to the third spacer 203; the second sealing component is arranged at one end of the fifth cavity 206 away from the third spacer 203; the first sealing component and the second sealing component wrap up and fix wires that pass through the first sealing component, the third spacer 203, and the second sealing component, so that the fifth cavity 206 is formed into a closed cavity. More preferably, the insulation sealant is poured into the closed fifth cavity 206. After being cured, the insulation sealant wraps around and fixes the circuit board and the wire in the fifth cavity 206. The wires are connected to the circuit board. Specifically, the wires passing through the first sealing component and the third spacer 203 are connected to an input end of the circuit board, and the wire passing through the second sealing component is connected to an output end of the circuit board. According to the preferred technical solution of this embodiment, the fifth cavity 206 can be formed into the closed cavity through the action of the first sealing component and the second sealing component. When insulation sealant is poured into the closed fifth cavity 206, the insulation sealant will not seep out from two ends of the fifth cavity 206. After being cured, the insulation sealant will wrap up and fix the circuit board and all elements and solder joints on the circuit board in the fifth cavity 206, playing a role of external insulation.

According to a preferred implementation, a fourth spacer 301 is arranged in the middle of the tail plug socket 30; and two sides of the fourth spacer 301 are respectively formed into a sixth cavity 302 used for accommodating the inner bracket component and a seventh cavity 303 for accommodating the circuit board, as shown in FIG. 9 or FIG. 10. Preferably, the first sealing components are arranged on the two sides of the fourth spacer 301; the second sealing component is arranged at one end of the seventh cavity 303 away from the fourth spacer 301; the first sealing components and the second sealing component wrap up and fix wires that respectively pass through the first sealing components, the fourth spacer 301, and the second sealing component, so that the seventh cavity 303 is formed into a closed cavity. More preferably, the insulation sealant is poured into the closed seventh cavity 303. After being cured, the insulation sealant wraps around and fixes the circuit board and the wire in the seventh cavity 303. The wires are connected to the circuit board. Specifically, the wires passing through the first sealing components and the fourth spacer 301 are connected to an input end of the circuit board, and the wire passing through the second sealing component is connected to an output end of the circuit board. According to the preferred technical solution of this embodiment, the seventh cavity 303 can be formed into the closed cavity through the action of the first sealing components and the second sealing component. When insulation sealant is poured into the closed seventh cavity 303, the insulation sealant will not seep out from two ends of the seventh cavity 303. After being cured, the insulation sealant will wrap up and fix the circuit board and all elements and solder joints on the circuit board in the seventh cavity 303, playing a role of external insulation.

Preferably, the circuit boards in the second cavity 104, the fifth cavity 206, and the seventh cavity 303 are provided with circuits that connect alternating current power at an input end to an output end; or rectification circuits that convert alternating current power at an input end into direct current power at an output end; or time control circuits that control powering on and powering off at the output end. More preferably, the rectification circuits and the time control circuits can be circuit structures in the prior art, which will not be elaborated here. There are various ways to supply power in the preferred technical solutions of this embodiment, which can be specifically outputting constant alternating current power, outputting constant direct current power, or outputting on-off controllable power.

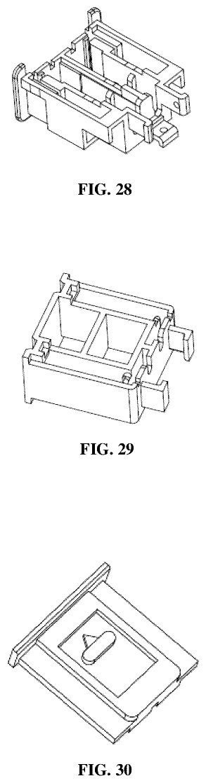

According to a preferred implementation, the inner bracket component includes an inner bracket and electrical elements arranged on the inner bracket. Preferably, the electrical elements on the inner bracket includes a copper tool, a fuse tube, a fuse tube leadwire, and the like. Preferably, a tail part of the inner bracket of the direct plug 10 has two relatively arranged hooks; and the hooks pass through through holes on the first spacer 102 and extend into the second cavity 104. The inner bracket of the direct plug 10 is as shown in FIG. 27. More preferably, the hooks of the inner bracket of the direct plug 10 form a sliding chute used for clamping the first sealing component. Preferably, a tail part of the inner bracket of the back plug 20 has three equilateral triangle-shaped hooks; and the hooks are hooked to the second spacer 202 and fix the inner bracket to the second spacer 202, so that the inner bracket of the back plug 20 cannot fall off from a shell. The inner bracket of the back plug 20 is as shown in FIG. 28. More preferably, a sliding chute used for clamping the first sealing component is arranged on the third spacer 203 of the back plug 20. Specifically, the sliding chute is located on one side of the fifth cavity 206 on the third spacer 203, as shown in FIG. 7. Preferably, a tail part of the inner bracket of the tail plug socket 30 has two relatively arranged hooks; and the hooks pass through through holes on the fourth spacer 301 and extend into the seventh cavity 303. The inner bracket of the tail plug socket 30 is as shown in FIG. 29. More preferably, the hooks of the inner bracket of the tail plug socket 30 form a sliding chute used for clamping the first sealing component. An inner bracket insertion sheet in FIG. 30 is used for being inserted onto the inner bracket of the direct plug 10 and the inner bracket of the back plug 20 to achieve an effect of preventing the fuse tube from falling off. On the other hand, the fuse tube can be replaced by opening the inner bracket insertion sheet.

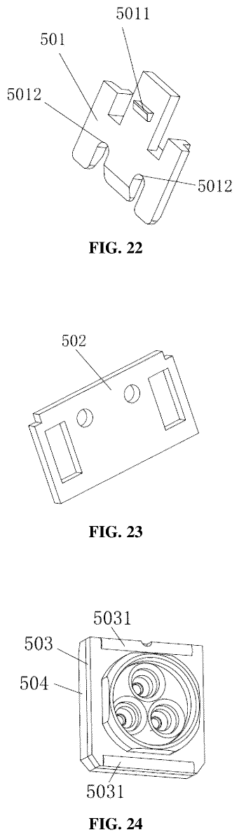

According to a preferred implementation, each of the first sealing components arranged on the two sides of the first spacer 102 and the two sides of the fourth spacer 301 includes a first wire locating piece 501 and a first stop piece 502, as shown in FIG. 22 and FIG. 23. Preferably, the first wire locating piece 501 is arranged in the second cavity 104 and the seventh cavity 303 and is clamped in the sliding chute formed by the hooks of the inner bracket to fix the inner bracket on the first spacer 102 or the fourth spacer 301. The sliding chute formed by the hooks of the inner bracket is as shown in FIG. 27 and FIG. 29. Preferably, the first stop piece 502 is a soft rubber stop piece arranged in the first cavity 103 and the sixth cavity 302 and located at a tail part of the inner bracket component to seal the through holes on the first spacer 102 and the fourth spacer 301, as shown in FIG. 23. Preferably, the first sealing component arranged in the fifth cavity 206 includes a first wire locating piece 501; and the first wire locating piece 501 is clamped in the sliding chute on the third spacer 203, as shown in FIG. 7. Preferably, each of the second sealing components includes a second wire locating piece 503 and a third wire locating piece 504, as shown in FIG. 24 to FIG. 26. More preferably, the second wire locating piece 503 is a hard rubber stop piece; the third wire locating piece 504 is a soft rubber stop piece; the second wire locating piece 503 and the third wire locating piece 504 are provided with two, three, or four through holes for allowing a wire to pass through; and a hole diameter of the through hole on the third wire locating piece 504 is smaller than a diameter of the wire, as shown in FIG. 24 to FIG. 26. According to the preferred technical solutions of this embodiment, each of the first sealing components arranged on the two sides of the first spacer 102 and the two sides of the fourth spacer 301 includes the first wire locating piece 501 and the first stop piece 502, so that the first wire locating pieces 501 can fix the inner brackets in the cavities on the shells and wrap up and fix the wires, and the first stop pieces 502 can seal the through holes in the spacers. According to the preferred technical solutions of this embodiment, the first sealing component arranged in the fifth cavity 206 includes the first wire locating piece 501; and the first wire locating piece 501 can wrap up and fix the wire passing through the spacer. FIG. 32 is a schematic diagram of combining the inner bracket of the direct plug 10 with the first stop piece 502. FIG. 33 is a schematic diagram of combining the inner bracket of the tail plug socket 30 and the first stop piece 502. According to the preferred technical solution of this embodiment, each of the second sealing components includes the second wire locating piece 503 and the third wire locating piece 504. The third wire locating piece 504 is the soft rubber stop piece, and the hole diameter of the through hole on the third wire locating piece 504 is smaller than the diameter of the wire, so that when the wires pass through the through holes in the third wire locating piece 504, the wires can be wrapped up. Through the second wire locating pieces 503 and the third wire locating pieces 504, the wires can be located, and the wires can be wrapped up to isolate the two sides of the wire locating pieces.

According to a preferred implementation, first bosses 5011 are arranged on one sides of the first wire locating pieces 501 that are in contact with the first spacer 102 of the direct plug 10, the third spacer 203 of the back plug 20, and the fourth spacer 301 of the tail plug socket 30; and the first bosses 5011 are clamped and fixed to mounting holes on the first spacer 102, the third spacer 203, and the fourth spacer 301, as shown in FIG. 22. The first wire locating pieces 501 are further provided with first recesses 5012 with downward openings; one end of each first recess 5012 away from the opening is of a semicircular structure having the same diameter as the diameter off the wire; second recesses 5013 with upward openings are further arranged at lower ends of the through holes, which are used for allowing the wires to pass through, on the first spacer 102, the third spacer 203, and the fourth spacer 301; each second recess 5013 is of a semicircular structure having the same diameter as the diameter of the wire; and the first recesses 5012 and the second recesses 5013 are abutted up and down to wrap up and fix the wires that pass through the first recesses 5012 and the second recesses 5013, as shown in FIG. 2 and FIG. 22. According to the preferred technical solution of this embodiment, the first wire locating pieces 501 are abutted with the semicircular structures of the second recesses 5013 on the spacers through the semicircular structures of the first recesses 5012, so that the wires passing through the recesses can be wrapped up to achieve a sealing effect, and spaces on two sides of the spacers are isolated.

According to a preferred implementation, the direct plug 10, the back plug 20, and the tail plug socket 30 are provided with fourth grooves 505 used for fixing the second wire locating pieces 503 and the third wire locating pieces 504; and a sum of thicknesses of each second wire locating piece 503 and each third wire locating piece (504) is greater than or equal to a width of each fourth groove 505, as shown in FIG. 2 to FIG. 10. Preferably, the sum of the thicknesses of each second wire locating piece 503 and each third wire locating piece 504 is greater than the width of each fourth groove 505, so that the fourth groove 505 is sealed using the elasticity of the third wire locating piece 504 to achieve an effect of preventing glue from seeping outwards. Second bosses 5031 are arranged on the second wire locating pieces 503; third bosses 5051 are arranged in the fourth grooves 505; and when the second sealing components are inserted into the fourth grooves 505, the second bosses 5031 and the third bosses 5051 are misaligned to fix the second wire locating pieces 503 in the fourth grooves 505, as shown in FIG. 3, FIG. 24, and FIG. 26. According to the preferred technical solution of this embodiment, the second bosses 5031 on the second wire locating pieces 503 and the third bosses 5051 in the fourth grooves 505 are misaligned with each other. Due to the elastic action of the third wire locating pieces 504, the second sealing components are fixed in the fourth grooves 505 and achieve the sealing effect.

A shell of the direct plug 10 includes an upper shell and a lower shell. The upper shell and the lower shell are clamped to each other. FIG. 1 shows a schematic diagram of the shell of the direct plug 10. In order to show the internal structure of the direct plug 10, FIG. 2 and FIG. 3 omit the upper shell. It is known that the fourth groove 505 used for fixing the second wire locating piece 503 and the third wire locating piece 504 is jointly formed by the upper shell and the lower shell. Similarly, a shell of the back plug 20 includes an upper shell and a lower shell. The upper shell and the lower shell are clamped to each other. FIG. 4 shows a schematic diagram of the shell of the back plug 20. In order to show the internal structure of the back plug 20, FIG. 5 to FIG. 7 omit the upper shell. It is known that the fourth groove 505 used for fixing the second wire locating piece 503 and the third wire locating piece 504 is jointly formed by the upper shell and the lower shell. Similarly, a shell of the tail plug socket 30 includes an upper shell and a lower shell. The upper shell and the lower shell are clamped to each other. FIG. 8 shows a schematic diagram of the shell of the tail plug socket 30. In order to show the internal structure of the tail plug socket 30, FIG. 9 and FIG. 10 omit the upper shell. It is known that the fourth groove 505 used for fixing the second wire locating piece 503 and the third wire locating piece 504 is jointly formed by the upper shell and the lower shell. The upper shells are arranged above the cavities of the direct plug 10, the back plug 20, and the tail plug socket 30, which can achieve a decorating and beautifying effect.

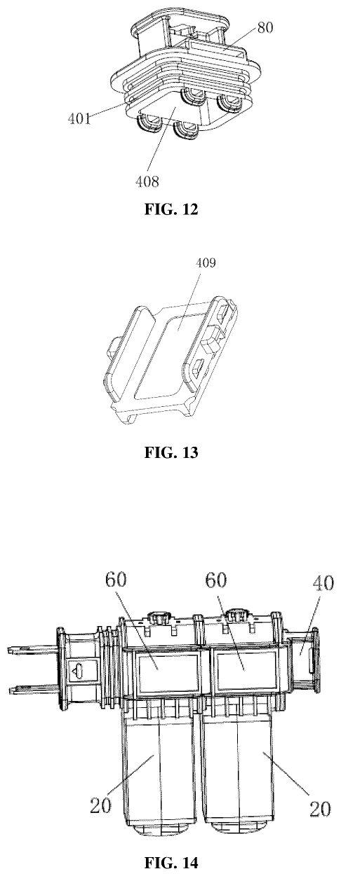

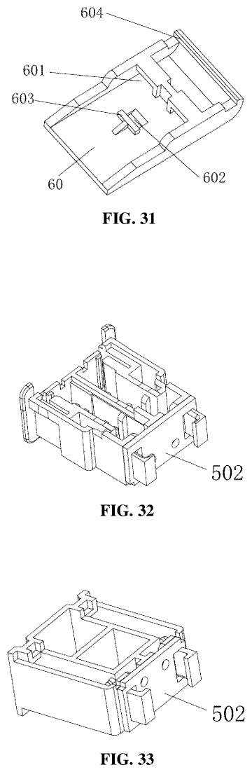

According to a preferred implementation, two insertion slots 601, as well as a first clamping slot 602 and a stop part 603 which are located between the two insertion slots 601, are arranged in the middle of one surface of each anti-separation buckle 60 that is in contact with the anti-separation buckle fixing part 70; a buckling part 604 is arranged at an end portion of the surface of the anti-separation buckle 60 that is in contact with the anti-separation buckle fixing part 70, as shown in FIG. 31; the anti-separation buckle fixing parts 70 arranged on the back plug (20) and the tail plug socket 30 include two insertion sheets 701, and an inverted buckle part 702 is also arranged between the two insertion sheets 701, as shown FIG. 5 and FIG. 9; when each anti-separation buckle 60 is fixed on each anti-separation buckle fixing part 70, the insertion sheets 701 are inserted into the insertion slots 601, the inverted buckle part 702 is buckled in the first clamping slot 602 and resists against the stop part 603, so that the anti-separation buckle 60 is unable to be separated from the anti-separation buckle fixing part 70; the direct plug 10, the back plug 20, and the end cap 40 are provided with the anti-separation clamping slots 80, as shown in FIG. 1, FIG. 5, and FIG. 12; and when at least two of the direct plug 10, the back plug 20, the tail plug socket 30, and the end cap 40 are connected, the buckling part (604) of the anti-separation buckle (60) is clamped in the anti-separation clamping slot (80), so as to firmly fix the joint, as shown in FIG. 14 to FIG. 21. Preferably, the anti-separation buckles 60 are provided with the buckling parts 604; the anti-separation buckle fixing parts 70 are arranged on two opposite surfaces of both the back plug 20 and the tail plug socket 30; and the anti-separation clamping slots 80 are arranged on two opposite surfaces of all the direct plug 10, the back plug 20, and the end cap 40, as shown in FIG. 1, FIG. 5, FIG. 9, FIG. 12, and FIG. 31. According to the preferred technical solution of this embodiment, the anti-separation buckles 60 are fixed at the anti-separation buckle fixing parts 70, and the buckling parts 604 of the anti-separation buckles 60 are clamped to the anti-separation clamping slots 80 to firmly fix the joints.

Specifically, the anti-separation buckles 60 are used in the following steps: (1) respectively inserting the two insertion sheets 701 into the two insertion slots 601, and buckling the inverted buckle part 702 to the first clamping slot 602 to resist against the stop part 603, so as to fix each anti-separation buckle 60 at each anti-separation buckle fixing part 70, without separation; (2) before connection to another plug component, pressing ends, away from insertion ports, of the anti-separation buckles 60 on the two sides of the shell, so that ends, close to the insertion ports, of the anti-separation buckles 60 on the two sides of the shell form a trumpet shape; (3) inserting the another plug component into a back insertion part of the back plug 20 with the anti-separation buckles 60 or the cavity of the tail plug socket 30 with anti-separation buckles 60; (4) removing the pressure on the anti-separation buckles 60, so that the buckling parts 604 of the anti-separation buckles 60 are clamped in the anti-separation clamping slots 80; and then pressing the buckling parts 604 of the anti-separation buckles 60 on the two sides of the shell at the same time, so that the anti-separation buckles 60 on the two sides of the shell are in a parallel state. This completes the connection to the plug component. The connected plug component needs to be removed, the other ends, away from one ends of the buckling parts 604, of the anti-separation buckles 60 on the two sides of the shell are pressed, so that the anti-separation buckles 60 on the two sides of the shell forms a trumpet shape. The buckling parts 604 are separated from the anti-separation clamping slots 80; and the connected plug component is pulled out.

According to a preferred implementation, the stop part 603 is of a T-shaped structure; a transverse edge of the stop part 603 is used for resisting against the inverted buckle part 702; and a vertical edge of the stop part 603 is of a structure that protrudes out of a surface of the anti-separation buckle 60 at a height gradually decreasing from one end close to the transverse edge to one end away from the transverse edge, as shown in FIG. 31. The inverted buckle part 702 is provided with a reinforcing rib 7021; and the reinforcing rib 7021 is of a structure having a protruding height that gradually decreases from one end close to the inverted buckle part 702 to one end away from the inverted buckle part 702, as shown in FIG. 5 or FIG. 9. According to the preferred technical solution of this embodiment, due to the structural designs of the stop part 603 and the inverted buckle part 702, the anti-separation buckle 60 will not be separated when it is fixed at the anti-separation buckle fixing part 70.

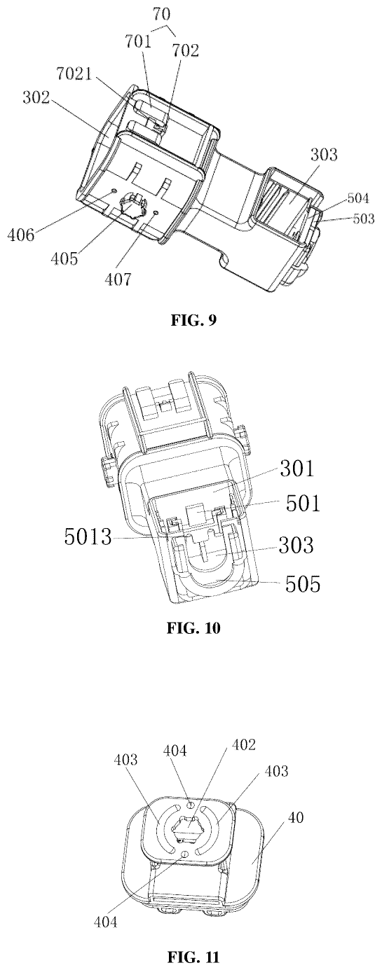

According to a preferred implementation, a fixed through hole 402 is arranged at a top of the end cap 40; two symmetrical arc-shaped grooves 403 are arranged on an outer circumference, concentric with the fixed through hole 402, of the top of the end cap 40; and a third recess 404 is arranged between the two arc-shaped grooves 403, as shown in FIG. 11. A fourth boss 405, a fifth boss 406, and a sixth boss 407 are arranged on a shell of each of the back plug 20 and the tail plug socket 30; and the fifth boss 406 and the sixth boss 407 are located on two sides of the fourth boss 405, as shown in FIG. 5 and FIG. 9. The top of the fourth boss 405 is, for example, in the shape of a plum blossom. The fifth boss 406 and the sixth boss 407 are, for example, convex points. When the back plug 20 with the end cap 40 and the tail plug socket 30 with the end cap 40 are connected to other plug components, the end caps 40 arranged in both the back plug 20 and the tail plug socket 30 are taken out and are fixed on the shells of the back plug 20 and the tail plug socket 30. The end caps 40 are fixed on the shells of the back plug 20 and the tail plug socket 30 in the following way: inserting the fourth bosses 405 into the fixed through holes 402 of the end caps 40, and respectively embedding the fifth bosses 406 and the sixth bosses 407 into the arc-shaped grooves 403; rotating the end caps 40 by 90° to clamp the plum blossom-shaped tops of the fourth bosses 405 into inner sides of the tops of the end caps 40 (which can ensure that the end caps 40 will not fall off in an up-down direction); and embedding the fifth bosses 406 and the sixth bosses 407 into the two third recesses 404 between the arc-shaped grooves 403 respectively from the arc-shaped grooves 403 (which can ensure that the end caps 40 will not rotate and move in a horizontal direction), as shown in FIG. 4 to FIG. 11. According to the preferred technical solution of this embodiment, the fixed through holes 402, the arc-shaped grooves 403, and the third recesses 404 are arranged on the end caps 40, and the fourth bosses 405, the fifth bosses 406, and the sixth bosses 407 are arranged on the shells of the back plugs 20 and the tail plug sockets 30. Through the cooperation of the various members, the end caps 40 can be fixed on the shells of the back plug 20 and the tail plug socket 30, which solves the problem of difficult storage when the end caps 40 are not in use. When the end cap 40 that has been fixed on the shell of the tail plug socket 30 needs to be removed, the end cap 40 is simply rotated by 90°, and then the fourth boss 405 on the shell of the tail plug socket 30 is withdrawn from the fixed through hole 402 in the center of the end cap 40.

Specifically, the end caps 40 are fixed on the shells of both the back plug 20 and the tail plug socket 30 in the following way: For example, when the tail plug socket 30 is inserted into the direct plug 10 or the back plug 20 for use, the end cap 40 of the tail plug socket 30 is removed from the tail plug socket 30; the fixed through hole 402 at the top of the end cap 40 sleeves the fourth boss 405 on the shell of the tail plug socket 30, and the two arc-shaped grooves 403 at the top of the end cap 40 are aligned with the fifth boss 406 and the sixth boss 407 on the two sides of the fourth boss 405; the end cap is rotated by 90° to enable the plum blossom-shaped top of the fourth boss 405 to be clamped to the inner side of the top of the end cap 40 and enable the fifth boss 406 and the sixth boss 407 on the shell of the tail plug socket 30 to be respectively transferred from the two arc-shaped grooves 403 into the third recesses 404 between the two arc-shaped grooves 403 on the end cap 40, so that the end cap 40 is fixed on the shell of the tail plug socket 30. Without an external force, the end cap 40 cannot be separated from the shell of the tail plug socket 30. When the end cap 40 that has been fixed on the shell of the tail plug socket 30 needs to be removed, the end cap 40 is simply rotated by 90°, so that the fifth boss 406 and the sixth boss 407 are embedded into the arc-shaped grooves 403 respectively from the two third recesses 404 between the arc-shaped grooves 403; and the fourth boss 405 on the shell of the tail plug socket 30 is withdrawn from the fixed through hole 402 in the center of the end cap 40.

Similarly, the end cap 40 on the back plug 20 can be fixed to the shell of the back plug 20 in the same way when it is not in use. Similarly, the end cap 40 fixed on the shell of the back plug 20 can be removed in the same way.

According to a preferred implementation, an accommodating chamber 408 is also formed on the end cap 40. The accommodating chamber 408 is used for placing standby fuse tubes. The accommodating chamber 408 is covered with an end cap stop piece 409, as shown in FIG. 12 and FIG. 13. Preferably, the end cap stop piece 409 is connected or removed by buckles on two sides and an end cap body.

In the description of the present disclosure, it should be noted that unless otherwise stated, “plurality” means two or more. Orientations or positional relationships indicated by the terms “upper”, “lower”, “left”, “right”, “inside”, “outside”, “front end”, “rear end”, “head part”, “tail part” and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms are not construed as limiting the present disclosure. In addition, the terms “first”, “second”, “third”, and the like are only for the purpose of description, and may not be understood as indicating or implying the relative importance.

In the description of the present disclosure, it should also be noted that unless otherwise specified and limited, the terms “mount”, “connect”, and “connection” should be broadly understood. For example, it can be a fixed connection, detachable connection, integrated connection, mechanical connection, electrical connection, direct connection, or indirect connection via an intermediate element. For those of ordinary skill in the art, the specific meanings of the aforementioned terms in the present disclosure can be understood according to specific conditions.

The foregoing descriptions are merely specific implementations of the present disclosure, but are not intended to limit the protection scope of the present disclosure. Any variation or replacement easily figured out by a person skilled in the art within the technical scope disclosed in the present disclosure shall fall within the protection scope of the present disclosure. Therefore, the protection scope of the present disclosure shall be subject to the protection scope of the claims. Please amend the claims as follows:

1. An assembled type waterproof power plug component, comprising a direct plug (10), a back plug (20), a tail plug socket (30), and an end cap (40), wherein
the direct plug (10), the back plug (20), and the end cap (40) are provided with sealing components; when at least two of the direct plug (10), the back plug (20), the tail plug socket (30), and the end cap (40) are connected, the sealing components are used for sealing joints;
spacers are arranged in the direct plug (10), the back plug (20), and the tail plug socket (30) to form cavities for placing circuit boards in the direct plug (10), the back plug (20), and the tail plug socket (30); first sealing components and/or second sealing components are respectively arranged at two ends of the cavities, so that the cavities are formed into closed cavities; insulation sealants are poured into the closed cavities; after being cured, the insulation sealants wrap up and fix the circuit boards in the cavities;
the back plug (20) and the tail plug socket (30) are further provided with anti-separation buckles (60) and anti-separation buckle fixing parts (70); the anti-separation buckles (60) are fixed at the anti-separation buckle fixing parts (70); anti-separation clamping slots (80) are further arranged on the direct plug (10), the back plug (20), and the end cap (40); and when at least two of the direct plug (10), the back plug (20), the tail plug socket (30), and the end cap (40) are connected, the anti-separation buckles (60) are buckled at the anti-separation clamping slots (80) to firmly buckle and fix the joints.

2. The assembled type waterproof power plug component according to claim 1, wherein a first sealing groove (101), a second sealing groove (201), and a third sealing groove (401) are respectively arranged on the direct plug (10), the back plug (20), and the end cap (40); and the sealing components are sealing rings placed in the first sealing groove (101), the second sealing groove (201), and the third sealing groove (401).

3. The assembled type waterproof power plug component according to claim 1, wherein a first spacer (102) is arranged in the middle of the direct plug (10); two sides of the first spacer (102) are respectively formed into a first cavity (103) used for accommodating an inner bracket component and a second cavity (104) for accommodating the circuit board; the first sealing components are arranged on the two sides of the first spacer (102); the second sealing component is arranged at one end of the second cavity (104) away from the first spacer (102); the first sealing components and the second sealing component wrap up and fix wires that respectively pass through the first sealing components, the first spacer (102), and the second sealing component, so that the second cavity (104) is formed into a closed cavity;
a second spacer (202) and a third spacer (203) are arranged in the back plug (20); two sides of the second spacer (202) are respectively formed into a third cavity (204) used for accommodating the inner bracket component and a fourth cavity (205) used for being connected to the direct plug (10), the back plug (20) or the end cap (40); two sides of the third spacer (203) are respectively formed into the fourth cavity (205) and a fifth cavity (206) used for accommodating the circuit board; the first sealing component is arranged at one end of the fifth cavity (206) close to the third spacer (203); the second sealing component is arranged at one end of the fifth cavity (206) away from the third spacer (203); the first sealing component and the second sealing component wrap up and fix wires that pass through the first sealing component, the third spacer (203), and the second sealing component, so that the fifth cavity (206) is formed into a closed cavity;
a fourth spacer (301) is arranged in the middle of the tail plug socket (30); two sides of the fourth spacer (301) are respectively formed into a sixth cavity (302) used for accommodating the inner bracket component and a seventh cavity (303) for accommodating the circuit board; the first sealing components are arranged on the two sides of the fourth spacer (301); the second sealing component is arranged at one end of the seventh cavity (303) away from the fourth spacer (301); the first sealing components and the second sealing component wrap up and fix wires that respectively pass through the first sealing components, the fourth spacer (301), and the second sealing component, so that the seventh cavity (303) is formed into a closed cavity;
the insulation sealants are poured into the closed second cavity (104), the closed fifth cavity (206), and the closed seventh cavity (303); after being cured, the insulation sealants wrap up and fix the circuit boards and the wires in the second cavity (104), the fifth cavity (206), and the seventh cavity (303); and
the circuit boards are provided with circuits that connect alternating current power at an input end to an output end; or rectification circuits that convert alternating current power at an input end into direct current power at an output end; or time control circuits that control powering on and powering off at the output end.

4. The assembled type waterproof power plug component according to claim 3, wherein the inner bracket component comprises an inner bracket and electrical elements arranged on the a tail part of the inner bracket of the direct plug (10) has two relatively arranged hooks; the hooks pass through through holes on the first spacer (102) and extend into the second cavity (104);
a tail part of the inner bracket of the back plug (20) has three equilateral triangle-shaped hooks; the hooks are hooked to the second spacer (202) and fix the inner bracket to the second spacer (202);
a tail part of the inner bracket of the tail plug socket (30) has two relatively arranged hooks; the hooks pass through through holes on the fourth spacer (301) and extend into the seventh cavity (303);
the hooks of the inner bracket of the direct plug (10) and the tail plug socket (30) form a sliding chute for clamping the first sealing components; and a sliding chute for clamping the first sealing component is arranged on one side of the fifth cavity (206) on the third spacer (203) of the back plug (20).

5. The assembled type waterproof power plug component according to claim 3, wherein each of the first sealing components arranged on the two sides of the first spacer (102) and the two sides of the fourth spacer (301) comprises a first wire locating piece (501) and a first stop piece (502); the first wire locating piece (501) is arranged in the second cavity (104) and the seventh cavity (303) and is clamped in the sliding chute formed by the hooks of the inner bracket, and the inner bracket is fixed on the first spacer (102) or the fourth spacer (301); the first stop piece (502) is a soft rubber stop piece arranged in the first cavity (103) and the sixth cavity (302) and located at a tail part of the inner bracket component to seal the through holes on the first spacer (102) and the fourth spacer (301);
the first sealing component arranged in the fifth cavity (206) comprises a first wire locating piece (501); the first wire locating piece (501) is clamped in the sliding chute on the third spacer (203);
each of the second sealing components comprises a second wire locating piece (503) and a third wire locating piece (504); the second wire locating piece (503) is a hard rubber stop piece; the third wire locating piece (504) is a soft rubber stop piece; the second wire locating piece (503) and the third wire locating piece (504) are provided with two, three, or four through holes for allowing a wire to pass through; and a hole diameter of the through hole on the third wire locating piece (504) is smaller than a diameter of the wire.

6. The assembled type waterproof power plug component according to claim 5, wherein first bosses (5011) are arranged on one sides of the first wire locating pieces (501) that are in contact with the first spacer (102) of the direct plug (10), the third spacer (203) of the back plug (20), and the fourth spacer (301) of the tail plug socket (30); the first bosses (5011) are clamped and fixed to mounting holes on the first spacer (102), the third spacer (203), and the fourth spacer (301);
the first wire locating pieces (501) are further provided with first recesses (5012) with downward openings; one end of each first recess (5012) away from the opening is of a semicircular structure having the same diameter as the diameter off the wire; second recesses (5013) with upward openings are further arranged at lower ends of the through holes, which are used for allowing the wires to pass through, on the first spacer (102), the third spacer (203), and the fourth spacer (301); each second recess (5013) is of a semicircular structure having the same diameter as the diameter of the wire; and the first recesses (5012) and the second recesses (5013) are abutted up and down to wrap up and fix the wires that pass through the first recesses (5012) and the second recesses (5013).

7. The assembled type waterproof power plug component according to claim 5, wherein the direct plug (10), the back plug (20), and the tail plug socket (30) are provided with fourth grooves (505) used for fixing the second wire locating pieces (503) and the third wire locating pieces (504); a sum of thicknesses of each second wire locating piece (503) and each third wire locating piece (504) is greater than or equal to a width of each fourth groove (505); second bosses (5031) are arranged on the second wire locating pieces (503); third bosses (5051) are arranged in the fourth grooves (505); and when the second sealing components are inserted into the fourth grooves (505), the second bosses (5031) and the third bosses (5051) are misaligned to fix the second wire locating pieces (503) in the fourth grooves (505).

8. The assembled type waterproof power plug component according to claim 1, wherein two insertion slots (601), as well as a first clamping slot (602) and a stop part (603) which are located between the two insertion slots (601), are arranged in the middle of one surface of each anti-separation buckle (60) that is in contact with the anti-separation buckle fixing part (70); a buckling part (604) is arranged at an end portion of the surface of the anti-separation buckle (60) that is in contact with the anti-separation buckle fixing part (70);
the anti-separation buckle fixing parts (70) arranged on the back plug (20) and the tail plug socket (30) comprise two insertion sheets (701), and an inverted buckle part (702) is also arranged between the two insertion sheets (701);
when each anti-separation buckle (60) is fixed on each anti-separation buckle fixing part (70), the insertion sheets (701) are inserted into the insertion slots (601), the inverted buckle part (702) is buckled in the first clamping slot (602) and resists against the stop part (603), so that the anti-separation buckle (60) is unable to be separated from the anti-separation buckle fixing part (70); and
when at least two of the direct plug (10), the back plug (20), the tail plug socket (30), and the end cap (40) are connected, the buckling part (604) of the anti-separation buckle (60) is clamped in the anti-separation clamping slot (80), so as to firmly fix the joint.

9. The assembled type waterproof power plug component according to claim 8, wherein the stop part (603) is of a T-shaped structure; a transverse edge of the stop part (603) is used for resisting against the inverted buckle part (702); a vertical edge of the stop part (603) is of a structure that protrudes out of a surface of the anti-separation buckle (60) at a height gradually decreasing from one end close to the transverse edge to one end away from the transverse edge; the inverted buckle part (702) is provided with a reinforcing rib (7021); and the reinforcing rib (7021) is of a structure having a protruding height that gradually decreases from one end close to the inverted buckle part (702) to one end away from the inverted buckle part (702).

10. The assembled type waterproof power plug component according to claim 1, wherein a fixed through hole (402) is arranged at a top of the end cap (40); two symmetrical arc-shaped grooves (403) are arranged on an outer circumference, concentric with the fixed through hole (402), of the top of the end cap (40); a third recess (404) is arranged between the two arc-shaped grooves (403);
a fourth boss (405), a fifth boss (406), and a sixth boss (407) are arranged on a shell of each of the back plug (20) and the tail plug socket (30); the fifth boss (406) and the sixth boss (407) are located on two sides of the fourth boss (405);
when the back plug (20) with the end cap (40) and the tail plug socket (30) with the end cap (40) are connected to other plug components, the end caps (40) arranged in both the back plug (20) and the tail plug socket (30) are taken out and are fixed on the shells of the back plug (20) and the tail plug socket (30); and
the end caps (40) are fixed on the shells of the back plug (20) and the tail plug socket (30) in the following way: inserting the fourth bosses (405) into the fixed through holes (402), rotating the end caps (40) by 90° to clamp the tops of the fourth bosses (405) into inner sides of the tops of the end caps (40), and embedding the fifth bosses (406) and the sixth bosses (407) into the two third recesses (404) between the arc-shaped grooves (403) respectively.
